(19) United States
(12) Patent Application Publication
(10) Pub. No.: US 2023/0259994 A1
(43) Pub. Date: Aug. 17, 2023

(54) REFERENCE-BASED SOFTWARE APPLICATION BLUEPRINT CREATION

(71) Applicant: SAP SE, Walldorf (DE)

(72) Inventors: Stefan Raffel, Spechbach (DE); Enfei Chong, Ittlingen (DE); Arjun Janardhan Reddy, Bengaluru (IN)

(21) Appl. No.: 17/670,188

(22) Filed: Feb. 11, 2022

(51) Int. Cl. G06Q 30/02; G06Q 10/08

(52) U.S. Cl. CPC G06Q 30/0283; G06Q 10/087

(57) ABSTRACT

Programs, systems, and methods for providing cloud-based provisioning, dynamic cost estimation, and automated cost reporting are described herein. In some embodiments, a software application blueprint may be created for providing applications, services, content and integrations to a user through a web service provider. The software application blueprint may comprise product landscapes including templates referencing inventories from a database to obtain elements of the applications, services, content, and integrations. The product landscapes may be connected to a TCO calculator and a TCO reporter for estimating cost and determining prices and reporting costs to the user.

### BACKGROUND

### 1. Field

Embodiments of the present teachings relate to software application blueprint creation. Specifically, embodiments of the present teachings relate to software application blueprint creation, dynamic cost estimation and automatic electronic reporting in connection with the software application product blueprint.

### 2. Related Art

Typically, the provision of cloud-based software application products and hybrid software application products are not as compact as applications stored on hosted machines. In typical cloud-based systems, a central application is surrounded by a plurality of peripheral services. These peripheral services typically have dependencies associated with other peripheral services. For example, typical software application products comprise heterogeneous runtime technologies, locations, and collaborating teams. The plurality of peripheral services and dependencies causes challenges for consistent provisioning and effective control of cost operations. Dynamic provisioning and cost control becomes extremely complex and confusing for administrators. Furthermore, interaction between the administrators and users regarding hosting and other cloud-based costs can be complex and confusing. As such, what is needed is a fully specified operational software application product blueprint that can be utilized as a computer-readable input for an orchestrated cloud-based instantiation of the runtime software application in a cloud-based product landscape.

### SUMMARY

Embodiments of the disclosure solve the above-described problems by providing programs, systems, and methods for providing a product landscape modeler to create architectural software application product blueprints. The software application product blueprints may comprise computer-readable instructions representing a bill of materials of a cloud product to read in products, services, and integrations. A first embodiment is directed to a method of cloud-based provisioning by a software application blueprint. The method comprises receiving, from an administrator, selection of a web service provider for a user, receiving, from the administrator, selection of templates referencing inventories for providing products to be included in the cloud-based provisioning, reading, from the inventories, elements associated with the products to be provided to the user, building the software application blueprint comprising at least one product landscape, wherein the at least one product landscape comprises the templates referencing the elements associated with the products in the inventories, and providing the products to the user by the software application blueprint via the web service provider.

A second embodiment is directed to One or more non-transitory computer-readable media storing computer-executable instructions that, when executed by a processor, perform a method of cloud-based provisioning by a software application blueprint. The method comprises receiving, from an administrator, selection of a web service provider for a user, receiving, from the administrator, selection of templates referencing inventories for providing products to be included in the cloud-based provisioning, reading, from the inventories, elements associated with the products to be provided to the user, building the software application blueprint comprising a plurality of product landscapes and shared products, wherein the plurality of product landscapes comprises the templates referencing the elements associated with the products in the inventories, and providing the products to the user by the software application blueprint via the web service provider.

A third embodiment is directed to a system for providing cloud-based provisioning by a software application blueprint. The system comprises a database, a display, displaying a user interface comprising a software application blueprint visualization representing the software application blueprint, a product landscape modeler configured to receive, by the user interface and from an administrator, selection of a web service provider for a user, receive, by the user interface, selection of products to be included in the software application blueprint for the cloud-based provisioning, generate the software application blueprint comprising one or more product landscapes comprising templates, wherein the templates make reference to elements associated with the products in an inventory of the database, read, from the inventory by the database, the elements associated with the products to be provided to the user, and provide the products to the user by the software application blueprint and the web service provider.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the disclosure will be apparent from the following detailed description of the embodiments and the accompanying drawing figures.

### BRIEF DESCRIPTION OF THE DRAWING FIGURES

Embodiments of the disclosure are described in detail below with reference to the attached drawing figures, wherein:

FIG. 1 depicts an exemplary flow diagram of software application blueprint entities, templates, and inventories;

FIG. 2A depicts an exemplary software application blueprint visualization;

FIG. 2B depicts an exemplary template;

FIG. 3A depicts an exemplary total cost of ownership (TCO) calculator workflow;

FIG. 3B depicts an exemplary automated TCO report;

FIG. 4 depicts an exemplary product landscape modeler, automated TCO report, and dynamic TCO calculator;

FIG. 5 depicts and exemplary process of creating a software application product blueprint and associated cost estimation and electronic reporting; and

FIG. 6 depicts an exemplary embodiment of a hardware platform for use with embodiments of the present disclosure.

The drawing figures do not limit the present teachings to the specific embodiments disclosed and described herein. The drawings are not necessarily to scale, emphasis instead being placed upon clearly illustrating the principles of the present teachings.

### DETAILED DESCRIPTION

The following detailed description references the accompanying drawings that illustrate specific embodiments in which the present teachings can be practiced. The embodiments are intended to describe aspects of the present teachings in sufficient detail to enable those skilled in the art to practice the present teachings. Other embodiments can be utilized, and changes can be made without departing from the scope of the present teachings. The following detailed description is, therefore, not to be taken in a limiting sense. The scope of the present teachings is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology can include a variety of combinations and/or integrations of the embodiments described herein.

Generally, embodiments of the present disclosure relate to providing a software application product blueprint by a product landscape modeler to assist administrators in roles as product architects of evolving cloud solution architectures, and as support and operations to maintain, support, troubleshoot and manage change by giving the administrators a transparent, easily consumed view of current product landscapes. In some embodiments, the product landscape modeler may be a tool to create a software application blueprint for a product landscape. The software application blueprint may comprise an exemplary bill of materials providing a list of references defined in a software repository or inventory. The software application blueprint may specify what needs may be provisioned for a cloud user. The administrator may customize aspects of service such as, for example, a web service provider, a platform, a data center, and a feature plan based on the needs of the user (e.g., customer, end user).

In some embodiments, the software application blueprint may provide a central cost control platform for estimating and electronic reporting of total cost of ownership (TCO). The software application blueprint may provide TCO planning and simulation for various provisioning variants. In some embodiments, the software application blueprint-based runtime instantiation may be the basis for complete and detailed TCO reporting. Furthermore, actual costs and estimated costs may be compared using the software application blueprint estimation and electronic reporting.

In some embodiments, the software application blueprint may comprise applications and services visible to the user as well as features provided only internally to a cloud-platform operator. The user may specify products, and the administrator may create computer-readable instructions of the software application blueprint to provision the products necessary to meet the user's specifications. In some embodiments, an operational software application product blueprint may be generated based on provisioning variants specified in connection with user specified parameters.

In some embodiments, cloud product landscapes may comprise three kinds of entities generally referenced herein as products; applications, services, and integrations provisioned at point-to-point scenario, tenant node, and content package. Application tenants may offer software application functionality to a user. The application may represent the subject of a product landscape. Other components of the product landscape may serve the application. In some embodiments, the application component may provide the initial URL for the customer. In some embodiments, services may be categorized and provide integration and kernel services, basic services, software application services, and the like. Furthermore, services may provide generic functionality to various applications rather than specific functional services. Any services may be shared between various application instances. In some embodiments, an integration may be a configured data transfer between applications and/or services. Each integration may be defined by one or more point-to-point connections. In some embodiments, a plurality of point-to-point connection specifications may be applied to a single integration.

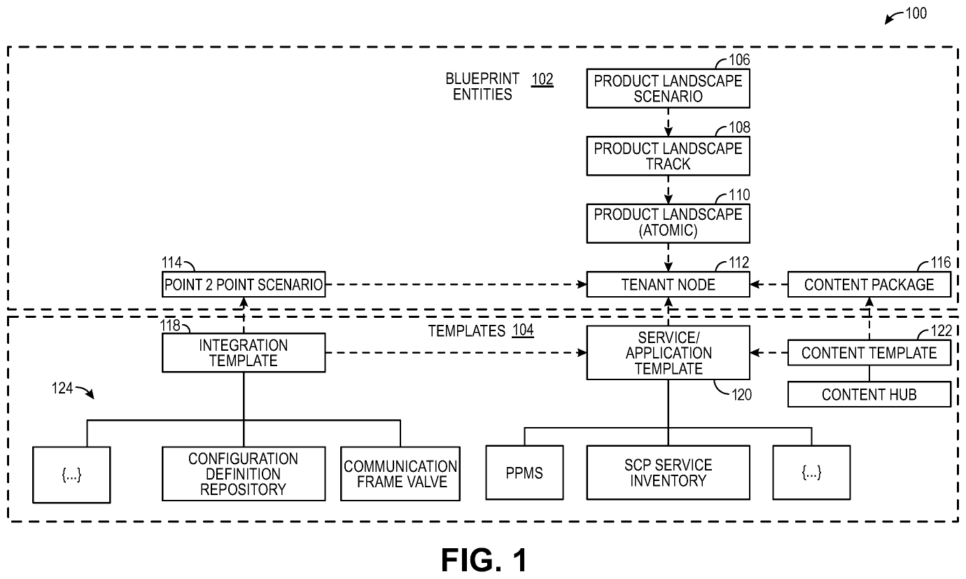

FIG. 1 depicts an exemplary product landscape modeler 100 comprising software application blueprint entities 102. In some embodiments, software application blueprint entities 102 comprise product landscape scenario 106, product landscape track 108, product landscape 110, point-to-point scenario 114, tenant node 112, and content package 116. In some embodiments, point-to-point scenario 114, tenant node 112, and content package 116 are proxies for templates 104. In some embodiments, templates 104 comprise integration template 118, service/application templates 120, and content templates 122. In some embodiments, templates 104 make reference to inventories 124 which, in some embodiments, may be software repositories.

In some embodiments, templates 104 may store the composition of products providing reference to the components of products but not storing the components. At templates 104, the product components in inventories 124 may be referenced. Any entities (e.g., products) may be referenced through the various templates 104. For example, templates 104 may comprise integration template 118, service/application templates 120, content templates 122, or any other templates that may reference entities to provide applications, services, and integrations. In some embodiments, content templates 122 may be visible to users such that users may download content packages.

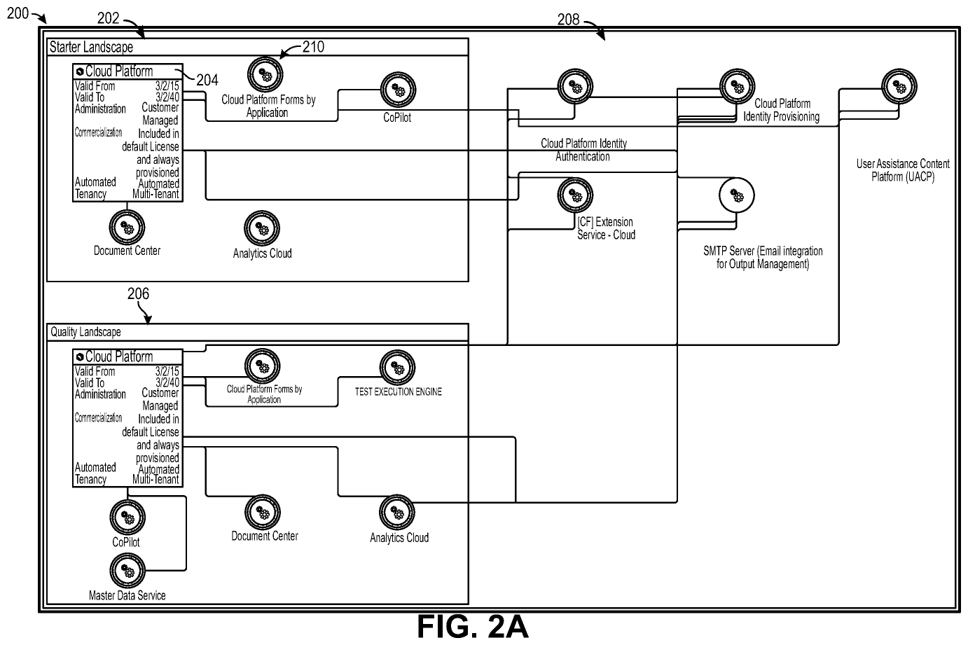

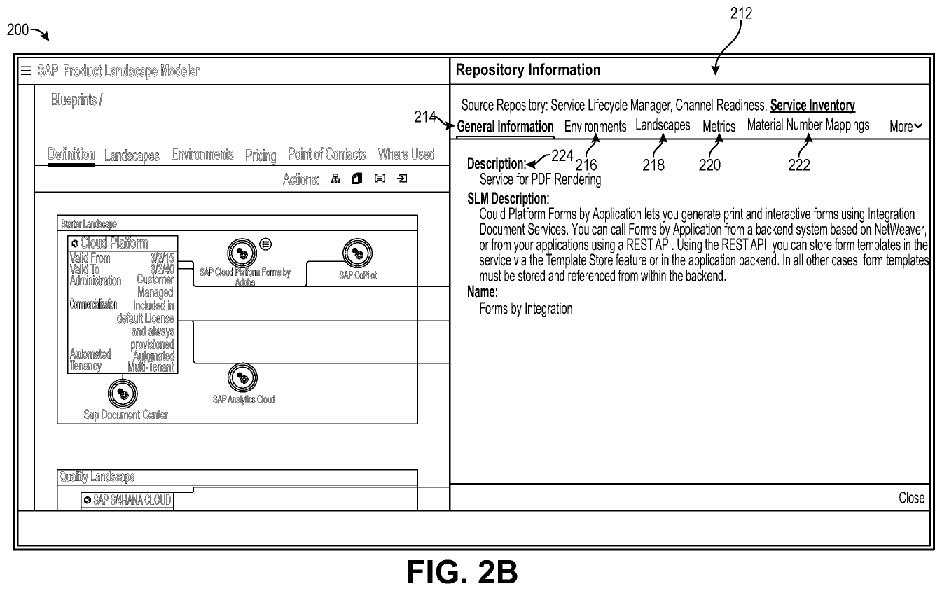

In some embodiments, templates 104 may reference the products and services and be stored for use by software application blueprint entities 102 to generate connected product landscapes by the product landscape 110, product landscape track 108, and product landscape scenario 106. In some embodiments, a software application blueprint 200 (FIG. 2A) comprise a digital bill of materials including all tenants that are necessary to provide cloud products (e.g., applications, services, and integrations). Template 212 may be accessible at tenant node 112 provided in software application blueprint 200 (FIG. 2A) comprising software application blueprint entities 102 which may be a representative of the corresponding tenant. At tenant node 112, all products, integrations, and services may be included. Tenant node 112 may be an aggregation of all read entities from inventories 124.

Furthermore, point-to-point scenario 114 may be a representation of integration template 118 and content package 116 may be a representation of content templates 122 associated with the software application blueprint. As such, a complete set of templates for each product may be included in the software application blueprint 200 comprising software application blueprint entities 102. Templates 104 may be combined to generate product landscape 110 as described in more detail below.

Next, products (e.g., applications, services, and integrations) may be assigned to a product landscape at product landscape 110. In some embodiments, an assignment of a product to a software application product blueprint and removal or replacement by another template may be valid for a specified period. In some embodiments, assignment of templates 104 to product landscape 110 may be specified with respect to automation and commercialization options. Commercialization options may include assigning optional components that may be restricted to specific contracts while automation options may be associated with standard product packages.

In some embodiments, product landscape track 108 may comprise the sequencing of a plurality of product landscapes with various roles in software application blueprint entities 102. Reuse services (i.e., ready-to-use services) may be shared between a plurality of product landscapes of product landscape track 108. In some embodiments, product landscape scenario 106 may connect a plurality of product landscape tracks. In some embodiments, connecting product landscape tracks to product landscape scenarios comprises adding integrations between software application templates of various product landscape tracks or sharing of services across product landscape tracks. The inclusion of a product landscape track within a product landscape scenario adds additional integrations and potentially extends the number of shared services rather than modifying the architecture of software application blueprint 200. The connections between templates, software application blueprints, and product landscapes are discussed further below.

FIGS. 2A-2B depict an exemplary visualization of software application blueprint 200 that may be modified by administrators to meet the demands of users (e.g., companies and end users). The exemplary visualization of software application blueprint 200 depicted in FIG. 2A comprises product landscapes such as, for example, starter landscape 202 and quality landscape 206. Various cloud landscapes may be added to software application blueprint 200. Any number of cloud landscapes may be provided to meet the needs of the user. For example, any software application product landscape providing products may be provided with starter landscape 202 and quality landscape 206. In some embodiments, software application blueprint 200 comprises software application blueprint entities 102. For example, product landscape 110 may be starter landscape 202 and the combination of starter landscape, quality landscape 206, and shared products 208 may represent product landscape track 108 and product landscape scenario 106.

Furthermore, each landscape comprises tenants. For example, starter landscape 202 comprises starter tenant 204. Each tenant may be provided in each product landscape. Each tenant may provide information describing the period for service, management, licensing information, and tenant information. In some embodiments, in a product landscape, an application or service tenant may directly depend on a plurality of services comprising specific software application blueprints. The representation of a template in software application blueprint 200 may be a proxy, and only represented by a tenant node of templates 104. For example, the blueprint 200 may change without one or more changes to the software application blueprint from which it depends. In some embodiments, each change to a product landscape in software application blueprint 200 may trigger a validity check comparing information of software application blueprint 200 with actual inventory data from corresponding inventories 124.

Shared products 208 may be any products that are shared between starter landscape 202 and quality landscape 206. As such, shared products 208 may be provided outside of each product landscape. Furthermore, services such as, for example, reuse service, may be shared between starter landscape 202 and quality landscape 206. The shared services may be connected to any product landscapes included in software application blueprint 200. As with the templates of the product landscapes, shared products 208 are represented by the tenant nodes shown in software application blueprint 200. In some embodiments, the tenant nodes may be selected to show the underlying templates and products as shown in FIG. 2B.

In some embodiments, product landscapes comprise templates that may be linked to products, services, and integrations. For example, starter landscape comprises tenant node 210 Cloud Platform Forms by Company representing template 212 depicted in FIG. 2B. Any of the templates may be viewed by selecting the visualized tenant nodes such as, for example, tenant node 210. When tenant node 210 is selected, the corresponding template 212 may be viewed as depicted in FIG. 2B.

In some embodiments, as shown in FIG. 2B an administrator may select tenant node 210 to view template 212. Tenant node 210 may be labeled by the name of the product that is provided and template 212 may show all data accessible through inventories 124 (i.e., repository information) associated with template 212. As shown, general information 214 about a product named “Application” is shown. The information shown along with Environments 216, Landscapes 218, Metrics 220, Material Number Mappings 222, and more, may be read out from inventories 124. Furthermore, template 212 may provide description 224 of the product. In some embodiments, the information in template 212 may be modified to read information from inventories 124. Any information stored in inventories 124 may be read and shown in template 212 accessible by selecting the tenant nodes shown in software application blueprint 200. The data stored in inventories 124 may comprise any information associated with the corresponding product. For example, selecting Environments 216, may display each environment (e.g., regions) in which “Application” service is accessible. Selecting Landscapes 218 may display the various product landscapes associated with template 212 to which “Application” is assigned. In some embodiments, dependencies of the product may also be stored in inventories 124 and accessible by the template 212.

In some embodiments, template 212 may be created by searching and selecting any inventories that include the applications, services, and integrations to be included in template 212. Products may be selected by accessing the inventory. When an inventory specific to a product is added to template 212, and when template 212 is added to software application blueprint 200, inventories 124 may be accessible through software application blueprint 200, the tenant node 210, and template 212. As such, a reference is created to the product, by template 212 in software application blueprint 200. All information associated with the product may be read from inventories 124 for any purpose including provisioning and dynamic TCO estimation and automated reporting. Furthermore, as described above, inventories 124 may be independent of product landscape modeler 100.

In some embodiments, when tenant node 112 referencing template 212 is added to software application blueprint 200, the administrator adding tenant node 112 referencing the product to be added may customize the period for use by the end user as well as licensing information, automated or customized setup, and tenancy information. The administrator may also customize the visibility with the customer such that the customer may see and customize the product delivery. Furthermore, the administrator may assign the product to be shared within software application blueprint 200 with various product landscapes or across various blueprints. In some embodiments, the products may be provisioned always, sometimes, upon request, or any other customizable way depending on the dependencies and if the products are optional or mandatory. As such, customization of the product may be assigned when assigning template 212 to the software application blueprint 200.

In some embodiments, software application blueprint 200 may be visualized as shown in FIG. 2A for ease of use by the administrator; however, software application blueprint 200 may actually be a computer-readable file such as, for example, JSON, XML, or any other computer-readable file format. Software application blueprint 200 may define the product landscapes and the tenant nodes. The computer-readable files may include information indicative of the product (i.e., applications, services, integrations, and content) such as, for example, title, type (e.g., application), description, identification number, software application type, subscription timeline, tenancy information, company management information, manual or automatic setup, license information, reuse information, cloud landscape reference, and associated template information which may include assigned technical inventories associated with the product. The attributes of the files may be read from technical inventories 124 associated with the template 212 defined in the computer-readable files. The computer-readable files may be automatically processed by computer-automated tools to execute the applications according to computer-readable files associated with software application blueprint 200. Software application blueprint 200 may be stored on computer-readable media executable by processors to perform the functions of generating the visualizations and performing the functions described herein.

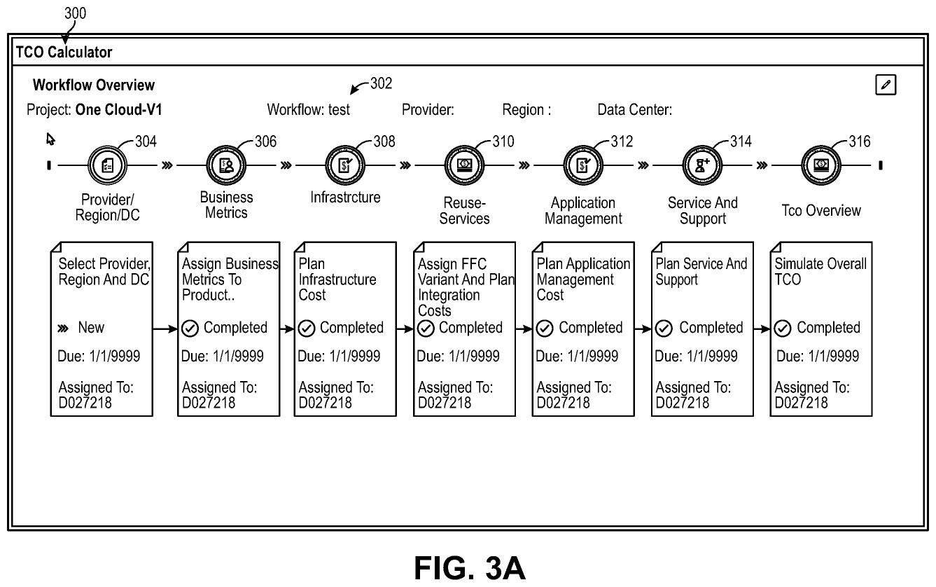

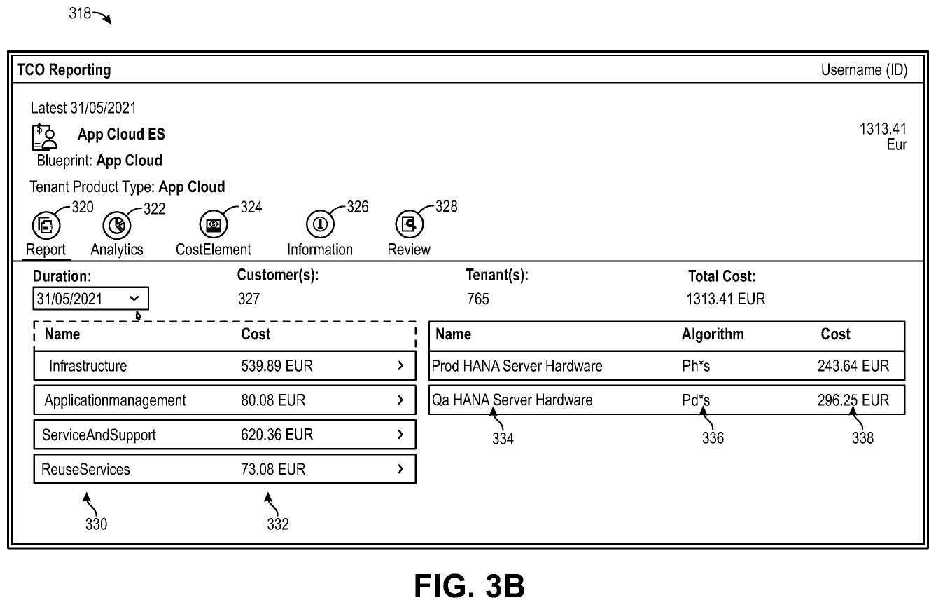

Turning to FIG. 3A, in some embodiments, the computer-readable file of software application blueprint 200 may be read into dynamic TCO calculator 300 for estimating and optimizing cost to simulate provisioning costs. All software application blueprints, including any associated product landscapes and templates may be imported into dynamic TCO calculator 300. In some embodiments, dynamic TCO calculator 300 may be a module or product landscape of product landscape modeler 100 and may be connected to the output of the various product landscapes associated with software application blueprint 200. As such, dynamic TCO calculator 300 may receive information indicative of the products, services, and integrations provisioned and dynamically calculate cost estimates. In some such embodiments, an artificial intelligence-based machine learning model may be employed to facilitate dynamic prediction of costs, which costs may vary depending on factors such as geographical cloud location, virtual server load, and time of day, for example. In these embodiments, the machine learning model may be trained based on predicted dynamic pricing of needed cloud-based services. Dynamic TCO calculator 300 may provide suggestions regarding alternative cloud deployment models that may influence TCO for a particular instantiation of a software application. As such, each product landscape in software application blueprint 200 may be added to the infrastructure cost associated with the user to which the software application blueprint is assigned. Furthermore, dynamic TCO calculator 300 may also be used dynamically and/or interactively to estimate costs, calculate actual costs, and compare the estimated costs and the actual costs in hindsight to provide insight into certain cloud deployment models as well as to refine the associated machine learning model for dynamic TCO calculator 300.

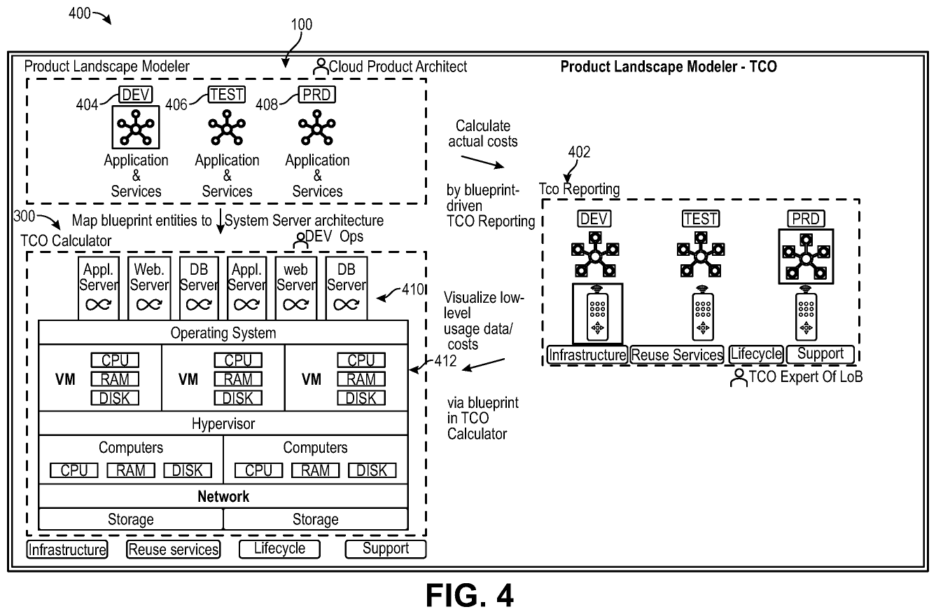

FIG. 3A depicts an exemplary TCO workflow 302 of dynamic TCO calculator 300. TCO calculator is depicted as a module in FIG. 4. Here, dynamic TCO calculator 300 generates an exemplary user interface visualization comprising backend computer-readable instructions executed by a processor to perform the functions included in TCO workflow 302. At first block 304 a web service provider, region, and data center (DC) for a client may be selected by the administrator. In some embodiments, the data center may be automatically selected based on the web service provider for the client, the region of the client, and the data may be read into dynamic TCO calculator 300 from software application blueprint 200.

At second block 306, performance metrics may be assigned to a software application product landscape. For example, tenant and customer performance metrics may be assigned to development landscape, test configuration landscape, various other production landscapes, performance configuration landscapes, cross landscapes, and the like. Furthermore, any products may be shared between the various cloud-based product landscapes.

At third block 308, infrastructure may be planned. Infrastructure may include all cloud product landscapes associated with tenant as described above. The product landscapes that are contemplated, as shown in FIG. 2A may be development landscape, test configuration landscape, production landscapes, performance configuration landscapes, cross landscapes, and the like. Each product included in software application blueprint 200 may have an associated cost provided by an associated hyperscaler catalogue for the product. Based on the price catalogue for each product associated with software application blueprint 200, the infrastructure cost may be assigned for estimation by dynamic TCO calculator 300. The infrastructure cost may be calculated based on the database storage, a number of instances, and the cost from the price catalogue. Blueprint 200 provides the structure to provide the outputs to dynamic TCO calculator 300 such that the total cost and the cost to run each product may be estimated and reduced in connection with automated tools as described herein.

At fourth block 310, reuse services may be managed. For example, a cross landscape tab may be accessed from the list of product landscapes. Shared services shared across a plurality of product landscapes may be available via the cross-landscape tab. The reuse services shared across the product landscapes may be accessed and added to dynamic TCO calculator 300. The reuse services may be displayed in the TCO workflow based on the addition of the reuse services in the software application blueprint 200 shown in FIG. 2A as shared products 208. In some embodiments, reuse services may be selected then the various product landscapes may be displayed and selected for addition of the reuse services in software application blueprint 200. Cross services may provide platform name, various shared landscapes, cost metric, unit price from the hyperscaler catalogue, performance metric, quantity, and the TCO. In some embodiments, when various products are added to software application blueprint 200, the various entities associated with the product are automatically included in the TCO workflow and may be displayed in the various workflow categories.

At fifth block 312, application management may be displayed and may be selected to plan and view application management costs. The application management costs may be associated with management of the applications provided over the period for which the applications are provided to the customer. At sixth block 314, service and support cost may be planned. The service and support cost may be estimated based on an historical average service and support costs for the products provided to the user. The cost estimates may be tracked and updated based on actual costs accrued by the user.

At seventh block 316, TCO overview may be displayed. TCO overview may provide the total cost and the cost breakdown of the estimated costs as determined by dynamic TCO calculator 300 receiving the output of software application blueprint 200. The TCO overview may be provided and edited by the administrator and may be provided to the user. Furthermore, an optimal data center may be provided based on the region, web service provider, and estimated costs compared using various data centers in the cost estimation.

In some embodiments, any parameters for calculating TCO may be modified in software application blueprint 200 and TCO workflow 302 such that various plans can be compared. For example, various regions may be selected, various providers may be selected, as well as various applications, services, and integrations may be called by template 212 from inventories 124. As such, any combination may be used to estimate TCO such that the user may receive optimal services.

The TCO workflow depicted in FIG. 3A may be implemented in development operations. As such, the workflow depicted in FIG. 3A may be simulated or real. The inputs into the system may be simulated such that the TCO is a cost estimate prior to implementation such that an expected cost estimate can be determined. Furthermore, the inputs may be used in real time for customers such that the cost is an actual cost for the customers. In some embodiments, the estimated costs and the actual costs may be compared to improve cost estimates.

From the designated products read into software application blueprint 200, the region of the client, and the web service provider for the client, an optimal data center may be selected for the customer. Blueprint 200 may provide the services needed for a cloud product and the customer as well as region information such that an optimal data center that can provide all necessary services can be selected during the provisioning process. The selection can be simulated during the TCO process to provide improved results to the customer.

FIG. 3B depicts an exemplary TCO report 318 associated with software application blueprint 200. In some embodiments, TCO report 318 may comprise report 320, analytics 322, cost elements 324, information 326, and review 328. In some embodiments, report 320 may comprise components 330 comprising infrastructure, application management, service and support, and reuse services, and associated costs 332. As depicted, infrastructure is selected and product name 334, algorithm 336 for calculating cost 338, and cost 338 of each product may be displayed. Here, the server user cost is applied as IaaS. In some embodiments, the cost may be a function of element cost as well as usage. Element cost may be read from the hyperscaler catalogue.

In some embodiments, analytics 322 may provide all analytics across the platform including any cost and payment statistics as well as trends and period coverages. Analytics 322 may be provided for software application blueprint 200 including associated products and each customer and may be provided for specified periods. In some embodiments, cost element 324 may store all cost elements used for calculating cost of each product for each component 330 of software application blueprint 200 and TCO report 318. Cost elements 324 may be any variable in algorithms 336 for calculating cost 338. In some embodiments, information 326 may provide any information related to software application blueprint 200, the products associated with software application blueprint 200, and the user associated with TCO report 318. In some embodiments, review 328 may provide final product and cost information to review and compare to previous periods consistent with an actual process of provisioning.

In an exemplary embodiment, a service and support calculation may comprise incident costs, support costs, and quantity. In a pay as you go plan, products and services may be used periodically by the user such that the user only pays as the user uses the product. The administrator may create the cost elements 324 and cost algorithms 336 such that the administrator may customize the plan for the user. For example, exemplary cost elements may comprise a shared development support cost (Sc), a price of development support incident (Pd), a number of customers associated with the incident (Nc), and a number of development support incidents (Nd). The exemplary cost elements may be used in an incident report to calculate the cost associated with the support. An exemplary algorithm calculating the cost by the exemplary cost elements may be

$$\frac{Sc}{Nc} + Pd * Nd .$$

The TCO reporter may be updated by adding cost elements to cost elements 324. The variables that may be used may be any elements that contribute to infrastructure, reuse services, lifecycle management, and development support and product support. As such, any costs associated with any products read into software application blueprint 200 may be calculated.

In some embodiments, software application blueprint 200 may be used for provisioning, TCO estimation, TCO reporting, and comparing TCO estimation and actual cost. FIG. 4 depicts a diagram 400 representing product landscape modeler 100 integrated with TCO reporter 402 and dynamic TCO calculator 300. As shown, product landscape modeler 100 comprises three exemplary software application blueprints: development 404, test 406, and product 408. In some embodiments, dynamic TCO calculator 300 and TCO reporter 402 generate TCO estimations and TCO reports comprising actual costs as describe above.

In some embodiments, software application blueprint products may be mapped to dynamic TCO calculator 300 for generating TCO estimations as described above in reference to TCO workflow above. As described above, product landscape modeler 100 may comprise software application blueprint 200 comprising template 212 for reading inventories 124 and provisioning products. Template 212 may reference inventories 124 for reading in various products for use by software application blueprint 200. In some embodiments, dynamic TCO calculator 300 comprises various servers 410 including an application server, a web server, a database server, as well as various other servers, and an operating system comprising various virtual machines 412 run on various computers in a network for estimating infrastructure costs and pricing by the administrator. As such, computing and storage costs and pricing may be assigned by the hyperscaler price catalogues that provides the price of the virtual machines, storage, and processing on the specified web service provider. The costs associated with the usage may include infrastructure costs, reuse service costs, lifecycle costs, and support costs as described in embodiments above. In some embodiments, the data center prescribed to the user may be determined based on the TCO estimates.

In some embodiments, TCO reporter 402 may be run time related as described above. A cost may be generated based on the usage of the products and the cost associated with the infrastructure, reuse services, lifecycle, and support of the products. As described in FIG. 3B above, the actual cost may be provided in TCO report 318 depicted in FIG. 3B. Any cost elements associated with the actual cost may be added in TCO report 318 under cost elements 324. As the customer uses the service provided, the cost may be calculated based on the algorithms provided in TCO report 318. As such, a full cost report may be calculated and provided to the administrator as well as the user.

In some embodiments, the TCO estimation and the actual TCO cost calculation may be compared to improve the estimation system. The TCO estimation may be compared to the actual cost to determine if large discrepancies exist. If large discrepancies exist, the TCO estimation may be updated to estimate actual costs more accurately. Furthermore, a different data center may be assigned that reduces the actual cost.

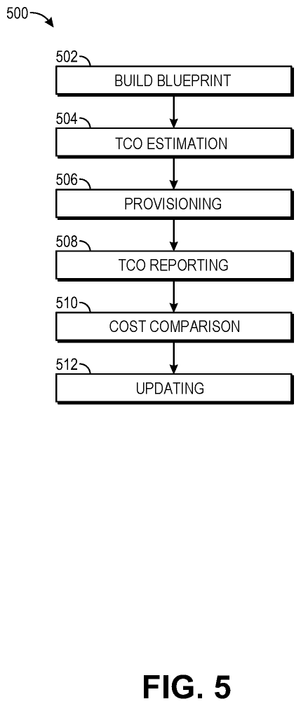

FIG. 5 depicts an exemplary process of software application blueprint creation, TCO estimation, provisioning, TCO reporting, cost comparison, and updating generally referenced by numeral 500. At step 502, the administrator may build software application blueprint 200. The administrator may build software application blueprint 200 by selecting templates including template 212 that references inventories 124 providing applications, services, and integrations generally referenced herein as products. The products may be assigned supporting the user requirements for service. Furthermore, the administrator may define a web service provider, region, and data center for providing the products. The web service provider and data center may be changed based on the region and the products required by the user. Furthermore, the data center selection may be automatically provided by the system based on the user requirements.

At step 504, TCO estimation may be simulated to estimate the costs and prepare pricing for the user. In some embodiments, a TCO landscape modeler may be added to software application blueprint 200 and connected to product landscapes in software application blueprint 200. As such, TCO calculator, as shown in FIG. 4 and described above, may calculate TCO based on infrastructure costs, reuse service costs, lifecycle costs, and support costs for a specified period for the products read into software application blueprint 200.

At step 506, the products may be provisioned to provide to the user. When the products have been prepared and simulated, the products may be provided to the user such that the user may access and run the products. The products may be run on a pay-as-you-go system such that costs are incurred based on usage. A period for usage may be specified as a contract between the user and the service or the provider.

At step 508, TCO reporting may be conducted as described in embodiments above. TCO reporter 402 may be added to software application blueprint 200 as a product landscape connected to various product landscapes of software application blueprint 200. The usage of the products may be tracked, and algorithms created by the administrator may be used to calculate the actual cost to the user. The actual cost may be based at least in part on usage and cost of IaaS from the hyperscaler catalogue comprising the cost elements associated with infrastructure costs, service costs, lifecycle costs, and support costs.

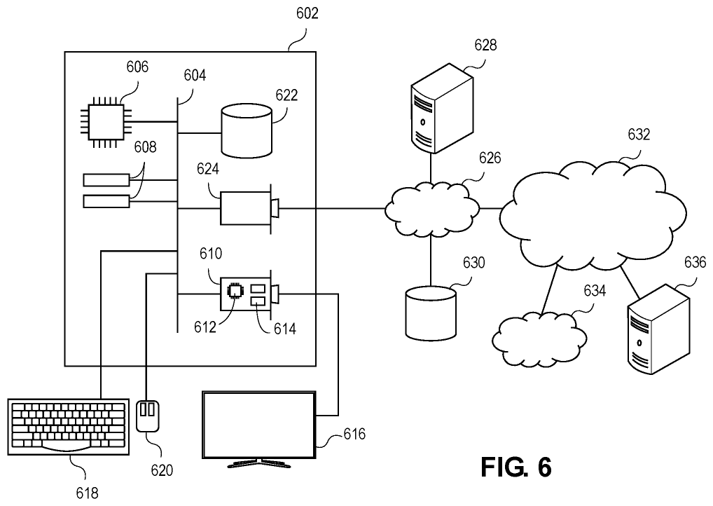

At step 510, the actual cost and the estimated cost may be compared as described in embodiments above. The estimated cost may be compared to the actual cost to determine any discrepancies. If discrepancies are detected, at step 512, software application blueprint 200 may be updated to better estimate actual costs or to optimize a data center based on new parameters. In embodiments described herein, product landscape modeler 100 and component included therein may comprise computer-readable media executable by computer 602 in FIG. 6.

FIG. 6 depicts an exemplary hardware platform that can form one element of certain embodiments of the disclosure, such embodiments including one or more computer-implemented methods. Computer 602 can be a desktop computer, a laptop computer, a server computer, or any other form factor of general- or special-purpose computing device. Depicted with computer 602 are several components, for illustrative purposes. In some embodiments, certain components may be arranged differently or absent. Additional components may also be present. Included in computer 602 is system bus 604, whereby other components of computer 602 can communicate with each other. In certain embodiments, there may be multiple busses or components may communicate with each other directly. Connected to system bus 604 is central processing unit (CPU) 606. Also attached to system bus 604 are one or more random-access memory (RAM) modules 608. Also attached to system bus 604 is graphics card 610. In some embodiments, graphics card 610 may not be a physically separate card, but rather may be integrated into the motherboard or the CPU 606. In some embodiments, graphics card 610 has a separate graphics-processing unit (GPU) 612, which can be used for graphics processing or for general purpose computing (GPGPU). Also on graphics card 610 is GPU memory 614. Connected (directly or indirectly) to graphics card 610 is display 616 for user interaction. In some embodiments no display is present, while in others it is integrated into computer 602. Similarly, peripherals such as keyboard 618 and mouse 620 are connected to system bus 604. Like display 616, these peripherals may be integrated into computer 602 or absent. Also connected to system bus 604 is local storage 622, which may be any form of computer-readable media and may be internally installed in computer 602 or externally and removably attached.

Non-transitory, computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

Finally, network interface card (NIC) 624 is also attached to system bus 604 and allows computer 602 to communicate over a network such as local network 626. NIC 624 can be any form of network interface known in the art, such as Ethernet, ATM, fiber, Bluetooth, or Wi-Fi (i.e., the IEEE 802.11 family of standards). NIC 624 connects computer 602 to local network 626, which may also include one or more other computers, such as computer 628, and network storage, such as data store 630. Generally, a data store such as data store 630 may be any repository from which information can be stored and retrieved as needed. Examples of data stores include relational or object-oriented databases, spreadsheets, file systems, flat files, directory services such as LDAP and Active Directory, or email storage systems. A data store may be accessible via a complex API (such as, for example, Structured Query Language), a simple API providing only read, write, and seek operations, or any level of complexity in between. Some data stores may additionally provide management functions for data sets stored therein such as backup or versioning. Data stores can be local to a single computer such as computer 628, accessible on a local network such as local network 626, or remotely accessible over Internet 632. Local network 626 is in turn connected to Internet 632, which connects many networks such as local network 626, remote network 634 or directly attached computers such as computer 636. In some embodiments, computer 602 can itself be directly connected to Internet 632.

Although the disclosure has been described with reference to the embodiments illustrated in the attached drawing figures, it is noted that equivalents may be employed, and substitutions made herein without departing from the scope of the disclosure as recited in the claims.

Having thus described various embodiments of the disclosure, what is claimed as new and desired to be protected by Letters Patent includes the following:

1. A method of cloud-based software application provisioning by a software application blueprint, the method comprising:
receiving, from an administrator, selection of a web service provider for a user;
receiving, from the administrator, selection of templates referencing inventories for providing products to be included in the cloud-based provisioning;
reading, from the inventories, elements associated with the products to be provided to the user;
building the blueprint comprising at least one product landscape,
wherein the at least one product landscape comprises the templates referencing the elements associated with the products in the inventories; and
providing the products to the user by the software application blueprint via the web service provider.

2. The method of claim 1, wherein the at least one product landscape is a plurality of product landscapes.

3. The method of claim 2, further comprising connecting at least one shared product to the plurality of product landscapes in the software application blueprint.

4. The method of claim 1, further comprising:
connecting a total cost of ownership (TCO) calculator to the at least one product landscape; and
calculating a cost associated with the products referenced in the software application blueprint and provided to the user.

5. The method of claim 4, wherein the cost associated with the products comprises infrastructure cost, service and support cost, lifecycle cost, and reuse services cost.

6. The method of claim 1, further comprising:
connecting a TCO reporter to the at least one product landscape;
receiving, by the TCO reporter, an output of the at least one product landscape; and
reporting a cost to the user of the products,
wherein the cost is based at least in part on an assigned cost to cost elements associated with the software application blueprint and a usage of the products by the user during a specified period.

7. The method of claim 1, further comprising determining a data center based on a region of the user, the web service provider, and the products associated with the software application blueprint.

8. One or more non-transitory computer-readable media storing computer-executable instructions that, when executed by a processor, perform a method of cloud-based application provisioning in connection with a software application blueprint, the method comprising:
receiving, from an administrator, selection of a web service provider for a user;
receiving, from the administrator, selection of templates referencing inventories for providing products to be included in the cloud-based provisioning;
reading, from the inventories, elements associated with the products to be provided to the user;
building the software application blueprint comprising a plurality of product landscapes and shared products,
wherein the plurality of product landscapes comprises the templates referencing the elements associated with the products in the inventories;
wherein the software application blueprint comprises computer-readable files to be automatically processed by computer-automated tools to execute the provisioning of the applications according to the computer-readable files,
providing the products to the user by the computer-readable files via the web service provider,
wherein the computer-readable files associated with the software application blueprint are consistent with the process of provisioning.

9. The media of claim 8, wherein the computer-executable instructions are further executed to perform connecting at least one shared product to the plurality of product landscapes in the software application blueprint.

10. The media of claim 8, wherein the computer-executable instructions are further executed to perform content deployment at least on one product in the software application blueprint.

11. The media of claim 8, wherein the computer-executable instructions are further executed to perform:
connecting a TCO calculator to the plurality of product landscapes; and
calculating an estimated cost based at least in part on the products referenced in the software application blueprint and an expected product usage by the user.

12. The media of claim 11, wherein the estimated cost associated with the products comprise infrastructure cost, service and support cost, lifecycle cost, and reuse services cost.

13. The media of claim 8, wherein the computer-executable instructions are further executed to perform:
connecting a TCO reporter to the plurality of product landscapes;
receiving, by the TCO reporter, an output of the plurality of product landscapes; and
calculating a cost to the user of the products of the plurality of product landscapes,
wherein the cost is based at least in part on an assigned cost to cost elements of the software application blueprint and usage of the products by the user.

14. The media of claim 8, wherein the computer-executable instructions are further executed to perform determining a data center based on a region of the user, the web service provider, and the products associated with the software application blueprint.

15. A system for providing cloud-based provisioning by a software application blueprint, the system comprising:
a database;
a display, displaying a user interface comprising a software application blueprint visualization representing the software application blueprint;
a product landscape modeler configured to
receive, by the user interface and from an administrator, selection of a web service provider for a user;
receive, by the user interface, selection of products to be included in the software application blueprint for the cloud-based provisioning;
generate the software application blueprint comprising one or more product landscapes comprising one or more templates,
wherein the one or more templates make reference to elements associated with the products in an inventory of the database;
read, from the inventory by the database, the elements associated with the products to be provided to the user; and
provide the products to the user by the software application blueprint and the web service provider.

16. The system of claim 15, wherein the one or more product landscapes is a plurality of product landscapes.

17. The system of claim 15, wherein the product landscape modeler is further configured to connect at least one shared product to the one or more product landscapes in the software application blueprint.

18. The system of claim 15,
a TCO calculator connected to the one or more product landscapes in the software application blueprint and configured to calculate an estimated cost based on the products referenced in the software application blueprint and an expected usage of the products by the user.

19. The system of claim 18, wherein the estimated cost associated with the products referenced in the software application blueprint comprises infrastructure cost, service and support cost, lifecycle cost, and reuse services cost.

20. The system of claim 15, further comprising:
a TCO reporter connected to the one or more product landscapes configured to
receive an output of the one or more product landscapes; and
calculate a cost to the user of the products,
wherein the cost is based at least in part on an assigned cost to cost elements of the software application blueprint and usage of the products by the user.
